(19) United States
(12) Patent Application Publication
(10) Pub. No.: US 2023/0289532 A1
(43) Pub. Date: Sep. 14, 2023

(54) Method for a Language Modeling and Device Supporting the Same

(71) Applicant: Siemens Aktiengesellschaft, München (DE)

(72) Inventors: Pankaj Gupta, München (DE); Yatin Chaudhary, München (DE)

(73) Assignee: Siemens Aktiengesellschaft, München (DE)

(21) Appl. No.: 18/040,682

(22) PCT Filed: Aug. 5, 2020
(86) PCT No.: PCT/EP2020/072038

§ 371 Date: Feb. 6, 2023

(51) Int. Cl. G06F 40/30; G06F 40/284

(52) U.S. Cl. CPC G06F 40/30; G06F 40/284

(57) ABSTRACT

Various embodiments include a computer-implemented method for a language modeling, LM. In some examples, the method includes: performing a topic modeling, TM, for at least one document to acquire a first type of topic representation which represents a topic distribution for each word in the at least one document; generating a second type of topic representation based on a predefined number of key terms for each topic of the topic distribution represented by the first topic representation; generating a TM representation comprising the first type of topic representation, the second type of topic representation, or a combination of the first type of topic representation and the second type of topic representation; receiving an input sentence for the LM; and performing the LM on the input sentence based on the TM representation.

### CROSS-REFERENCE TO RELATED APPLICATIONS

This application is a U.S. National Stage Application of International Application No. PCT/EP2020/072038 filed Aug. 5, 2020, which designates the United States of America, the contents of which are hereby incorporated by reference in their entirety.

### TECHNICAL FIELD

The present disclosure relates to neural languages. Various embodiments of the teachings herein include an understanding method, and/or methods for composing topic modeling and language modeling, and devices supporting the same.

### BACKGROUND

Language models (LMs) (Mikolov et al., 2010; Peters et al., 2018) have recently gained success in natural language understanding by predicting the next (target) word in a sequence given its preceding and/or following context(s), accounting for linguistic structures such as word ordering. However, LM are often contextualized by an n-gram window or a sentence, ignoring global semantics in context beyond the sentence boundary especially in modeling documents.

Topic models (TMs) such as LDA (Blei et al., 2001) facilitate document-level semantic knowledge in the form of topics, explaining the thematic structures hidden in a document collection. In doing so, they learn document-topic associations in generative fashion by counting word-occurrences across documents. Essentially, the generative framework assumes that each document is a mixture of latent topics, i.e., topic-proportions and each latent topic is a unique distribution over words in a vocabulary. Beyond a document representation, topic models also offer interpretability via topics (a set of key terms) .

While LM captures sentence-level (short-range dependencies) linguistic properties, they tend to ignore the document-level (long-range dependencies) context across sentence boundaries. It has been shown that even by considering multiple preceding sentences as the context to predict the current word, it is often difficult to capture long-term dependencies beyond a distance of 200 words in context.

Composing topic models and language models enhance language understanding to a broader source of document-level context beyond sentences via topics.

According to prior art, while introducing topical semantics in language models, incorporate latent document topic proportions are approached and topical discourse in sentences of the document are ignored leading to suboptimal textual representations.

### SUMMARY

Various embodiments of the teachings herein include a computer-implemented method for a language modeling, LM, the method comprising: performing (S302) a topic modeling, TM, for at least one document to acquire a first type of topic representation which represents a topic distribution for each word in the at least one document; generating (S304) a second type of topic representation based on a predefined number of key terms for each topic of the topic distribution represented by the first topic representation; generating (S306) a TM representation comprising the first type of topic representation, the second type of topic representation, or a combination of the first type of topic representation and the second type of topic representation; receiving (S308) an input sentence for the LM; and performing (S310) the LM on the input sentence based on the TM representation.

In some embodiments, the predefined number of key terms for each topic is extracted from the first topic representation by using a decoding weight parameter which represents a word distribution for each topic of the at least one document.

In some embodiments, the first type of topic representation further represents a topic proportion within the at least one document.

In some embodiments, the second type of topic representation is generated based on a topic embedding vector computed from the key terms.

In some embodiments, each entry of the topic embedding vector is associated with a topic, and wherein the topic embedding vector is, for generating the second type of the topic representation, weighted by the topic proportion of the associated topic within the at least one document.

In some embodiments, an output state for an output word is generated by the LM in response to the input sentence, and the output state is combined with the TM representation.

In some embodiments, the output state and the TM representation are combined by a sigmoid function.

In some embodiments, the input sentence is an incomplete sentence, and performing the LM includes completing the incomplete sentence based on the TM representation.

In some embodiments, the input sentence is a complete sentence which is extracted from the at least one document.

In some embodiments, the input sentence is excluded from the at least one document excludes the input sentence, and further comprising: performing the TM for the input sentence to acquire a first type of topic representation for the input sentence, wherein at least one of output words generated by the LM is excluded from the input sentence; and generating a second type of topic representation for the input sentence.

In some embodiments, the TM representation is generated to further comprise the first type of topic representation for the input sentence, the second type of topic representation for the input sentence, or a combination of the first type of topic representation for the input sentence and the second type of topic representation for the input sentence.

In some embodiments, performing the LM includes performing text retrieval based on the TM representation.

As another example, some embodiments include an apparatus (100) configured to perform one or more of the methods described herein.

As another example, some embodiments include a computer program product comprising executable program code configured to, when executed, perform one or more of the methods described herein.

As another example, some embodiments include a non-transitory computer-readable data storage medium comprising executable program code configured to, when executed, perform one or more of the methods described herein.

### BRIEF DESCRIPTION OF THE DRAWINGS

The disclosure is explained in yet greater detail with reference to exemplary embodiments depicted in the drawings as appended. The accompanying drawings are included to provide a further understanding of the present disclosure and are incorporated in and constitute a part of the specification. The drawings illustrate example embodiments of the present disclosure and together with the description serve to illustrate the principles of the disclosure. Other embodiments of the present disclosure and many of the intended advantages of the present disclosure will be readily appreciated as they become better understood by reference to the following detailed description. Like reference numerals designate corresponding similar parts.

The numbering of method steps is intended to facilitate understanding and should not be construed, unless explicitly stated otherwise, or implicitly clear, to mean that the designated steps have to be performed according to the numbering of their reference signs. In particular, several or even all of the method steps may be performed simultaneously, in an overlapping way or sequentially.

FIG. 1 shows an example for demonstrating a motivation incorporating teachings of the present disclosure;

FIG. 2 shows an example for demonstrating a motivation incorporating teachings of the present disclosure;

FIG. 3 shows an example of a method for a language modeling incorporating teachings of the present disclosure;

FIG. 4 shows an example of a method for a language modeling incorporating teachings of the present disclosure;

FIG. 5 shows an example of applications for language modeling incorporating teachings of the present disclosure;

FIG. 6 shows an example of applications for language modeling incorporating teachings of the present disclosure;

FIG. 7 shows an apparatus incorporating teachings of the present disclosure;

FIG. 8 shows a schematic block diagram illustrating a computer program product incorporating teachings of the present disclosure; and

FIG. 9 shows a schematic block diagram illustrating non-transitory computer-readable data storage medium incorporating teachings of the present disclosure.

### DETAILED DESCRIPTION

In some embodiments of the present disclosure, a computer-implemented method for a language modeling, LM, comprises performing a topic modeling, TM, for at least one document to acquire a first type of topic representation which represents a topic distribution for each word in the at least one document; generating a second type of topic representation based on a predefined number of key terms for each topic of the topic distribution represented by the first topic representation; generating a TM representation comprising the first type of topic representation, the second type of topic representation, or a combination of the first type of topic representation and the second type of topic representation; receiving an input sentence for the LM; and performing the LM on the input sentence based on the TM representation.

The predefined number of key terms for each topic may be extracted from the first topic representation by using a decoding weight parameter which represents a word distribution for each topic of the at least one document.

The first type of topic representation may further represent a topic proportion within the at least one document. The second type of topic representation may be generated based on a topic embedding vector computed from the key terms.

Each entry of the topic embedding vector may be associated with a topic, and wherein the topic embedding vector is, for generating the second type of the topic representation, weighted by the topic proportion of the associated topic within the at least one document.

An output state for an output word may be generated by the LM in response to the input sentence, and the output state may be combined with the TM representation. The output state and the TM representation may be combined by a sigmoid function.

The input sentence may be an incomplete sentence, and step of performing the LM may include completing the incomplete sentence based on the TM representation. The input sentence may be a complete sentence which is extracted from the at least one document.

In some embodiments, the input sentence may be excluded from the at least one document excludes the input sentence, and the method may further comprise: performing the TM for the input sentence to acquire a first type of topic representation for the input sentence, wherein at least one of output words generated by the LM is excluded from the input sentence; and generating a second type of topic representation for the input sentence.

The TM representation may be generated to further comprise the first type of topic representation for the input sentence, the second type of topic representation for the input sentence, or a combination of the first type of topic representation for the input sentence and the second type of topic representation for the input sentence.

In some embodiments, performing the LM may include performing text retrieval based on the TM representation.

In some embodiments, a computer program product comprises executable program code configured to, when executed, perform one or more of the method described herein.

In some embodiments, a non-transitory computer-readable data storage medium stores executable program code configured to, when executed, perform one or more of the methods described above.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

In machine learning (ML) and natural language processing (NLP), a topic modeling (TM) may be a type of statistical model for discovering the abstract (latent) “topics” that occur in a collection of documents. TM may be a frequently used text-mining tool for discovery of hidden semantic structures in a text body. TMs are also referred to as probabilistic topic models, which refer to statistical algorithms for discovering the latent semantic structures of extensive text bodies. TM may help to organize and offer insights for better understanding large collections of unstructured text bodies. Meanwhile, language modeling (LM) is the task of assigning a probability distribution over a sequence of words. Typically, language modelings are applied at sentence-level.

In some embodiments, TM may be a neural variational document model (Miao et al. “Neural variation inference for text processing”, 2016). LM according to an embodiment of the present disclosure may be a LSTM model (Hochreiter & Schmidhuber, “Long short-term memory”, 1997). In this disclosure, TM may be also referred to as neural topic modeling (NTM), and LM may be also referred to as neural language modeling (NLM).

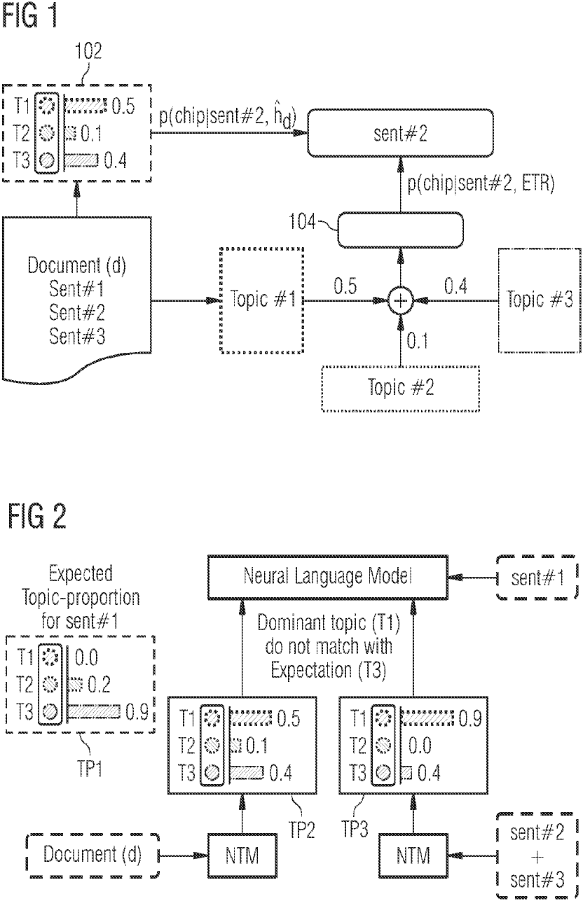

FIG. 1 shows an example for demonstrating a motivation of the present disclosure. In FIG. 1, a latent document-topic proportion 102 and an explainable topic representation 104 may be extracted from a document d. The latent document-topic proportion 102 may be a topic proportion, but does not provide an explanatory representation for each latent topic. In this example, the latent topics may be topic #1, topic #2 and topic #3. The explainable topic representation 104 may be a vector representation obtained from a set of high-probability terms in its topic-word distribution. The explainable topic representation 104 may be generated based on, for example, top-5 key terms correspondingly explaining each latent topic.

In FIG. 1, the document d may include a sentence #1, a sentence #2 and a sentence #3. The sentence #1 may be “An integrated circuit (IC) is a set of electronic circuits used for computer processor”. The sentence #2 may be “Production of chip is a multi-step process”. The sentence #3 may be “Sales are expected to grow 2.7% to 79.3 billion dollars, the largest market share in future”. In FIG. 1, the top-5 key terms for the topic #1 may be “share, inventing, billion, sales and market”. The top-5 key terms for the topic #2 may be “computer, unix, linux, android and smartphone”. The top-5 key terms for the topic #3 may be “electronic, circuit, processor, silicon and transistor”.

While augmenting LMs with topical semantics, existing approaches incorporate latent document-topic proportions and ignore an explanatory representation for each latent topic of the proportion. As shown in FIG. 1, the explainable topic representation 104 provides more fine-grained outlook of document semantics context than a latent document-topic representation 102 (also denoted as ĥd in FIG. 1) for prediction of word “chip”.

It may be observed that the context in sentence #2 cannot resolve the meaning of the word chip. However, introducing ĥ_{d} with complementary explainable topics (collections of key terms) provides an abstract (latent) and a fine granularity (explanatory) outlook, respectively.

FIG. 2 shows an example for demonstrating a further motivation of the present disclosure. As shown in FIG. 2, negative influence via sentence-level topical discourse mismatch is described. In FIG. 2, a sentence in a document may have a different topical discourse than its neighboring sentences or the document itself. As illustrated in FIG. 2, a TM generates two different document-topic proportions (TP) for input document d and sentence #2 + sentence #3 while modeling sentence #1 in the NLM. Observe that the sent#1 expects a topic proportion dominated by topic T3 (electronics) as in TP1; however, TM generates TP2 or TP3 due to input d or sentence #2 + sentence #3, respectively, where both the document-topic proportions are dominated by the topic T1 about marketing. Therefore, there is need to deal with such topical discourse mismatch for each sentence in the document.

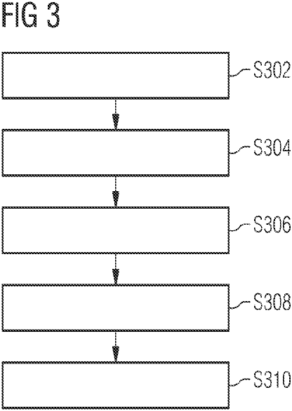

FIG. 3 shows an example of a method for a language modeling (LM) incorporating teachings of the present disclosure. The steps described in FIG. 3 may be performed by an apparatus 100 for a language modeling (LM) as shown in FIG. 7.

In step S302, the apparatus may perform a topic modeling (TM) for at least one document such as to acquire a first type of topic representation. The document may be a set of text, for example, industrial tender document, service report, specification document, etc. The first type of topic representation may be referred to as a latent topic representation (LTR).

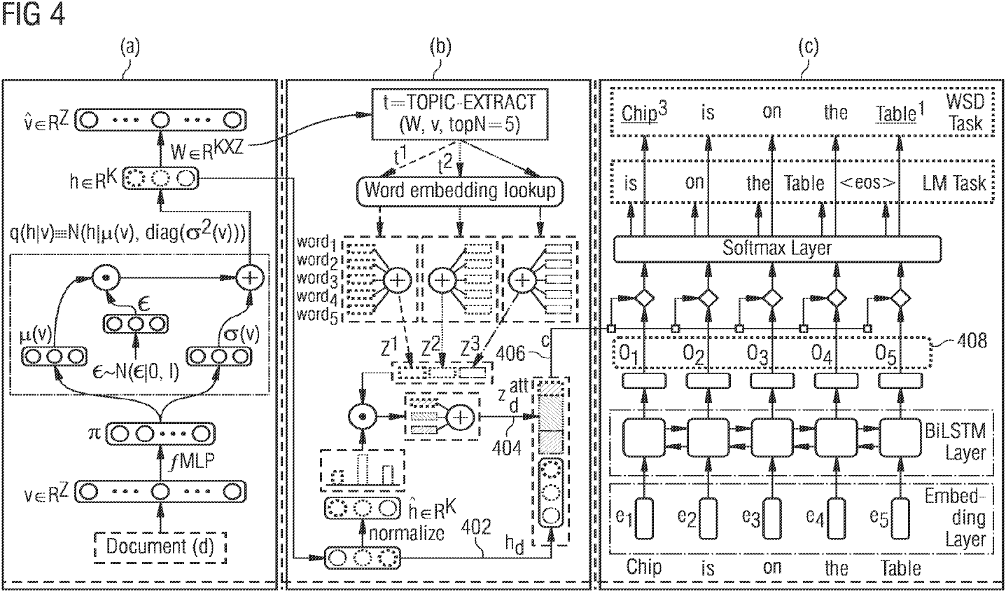

The first type of topic representation may represent topic distribution for each word in the at least one document. Further, the first type of topic representation may represent topic proportion within the at least one document. Thus, the first type of topic representation may be represented by a topic vector h which is an abstract (latent) representation of topic-word distributions for K topics and represents a document-topic proportion (association) as a mixture of K latent topics about the at least on document being modeled. Precisely, each scalar value h^{k} ∈ R denotes the contribution of kth topic in representing a document d by h. Here, h may be denoted as hd for an input document d, and hd may be the first type of topic representation. Detailed procedures regarding step S302 is described in FIG. 4.

FIG. 4 shows an example of a method for a language modeling (LM) incorporating teachings of the present disclosure. FIG. 4(a) shows an example of TM for generating a topic vector h for input document d. FIG. 4(b) shows an example of processes to generate the first type of topic representation 402, a second type of topic representation 404 and a TM representation 406. FIG. 4(c) shows an example of LM according to an embodiment of the present disclosure.

As shown in FIG. 4(a), a document d may be input to TM, and topic vector h may be generated by TM. TM may be an unsupervised generative model that learns to regenerate an input document vector v using a continuous latent semantic (topic) representation h, sampled from a prior Gaussian distribution p(h). TM may adopt a neural variational inference framework (Miao et al. “Neural variation inference for text processing”, 2016) to compute a posterior Gaussian distribution q(h|v), approximating the true prior p(h).

It may be considered that a document d represented as a bag-of-words (BoW) vector v = [v1, ..., vi, ..., vZ], where vi ∈ Z≥0 denotes a count of the ith word in vocabulary of size Z. The process of generating the first type of topic representation may include following steps 1 and 2 (also described in Algorithm 1: line #9-18):

- Step 1: first type of topic representation h ∈ RK may be sampled by encoding v using an MLP encoder q(h|v) i.e., h ~ q(h|v), as shown in FIG. 4(a), where l₁ and l₂ are linear transformations and I is the identity matrix. For each input v, encoder network may generate the parameters µ(v) and σ(v) (mean and deviation of v, respectively) required to parameterize the approximate posterior probability distribution in diagonal Gaussian form and samples h from it (Algorithm 2: lines #13-20).

$$\text{h \textasciitilde q} \left(\text{h} \left|\text{v}\right)\right) ≡ \text{N} \left(\text{h} \left|μ \left(\text{v}\right) , \text{diag} \left({\text{σ}}^{2} \left(\text{v}\right)\right)\right)\right) \qquad \text{[Equation 1]}$$

- Step 2: Conditional word probabilities p(vi|h) are computed independently for each word, using multinomial logistic regression with parameters shared across all documents by using equation 2.

$$\text{p} \left({\text{v}}_{\text{i}} \left|\text{h}\right)\right) = \frac{exp \left\{{\text{h}}^{\text{T}} {\text{W}}_{: , \text{i}} + {\text{b}}_{\text{i}}\right\}}{{\sum }_{\text{j=1}}^{\left|\text{Z}\right|} exp \left\{{\text{h}}^{\text{T}} {\text{W}}_{: , \text{j}} + {\text{b}}_{\text{j}}\right\}} \qquad \text{[Equation 2]}$$

where W∈R^{K×|Z|} & b∈R^{|Z|} are TM decoding parameters.

The word probabilities p(vi|h) may be further used to compute document probability p(v|h) conditioned on h. By marginalizing p(v|h) over latent representation h, likelihood p(v) of document d may be acquired as equation 3.

$$\text{p} \left(\text{v}\right) = {\int }_{\text{h\textasciitilde p} \left(\text{h}\right)} \text{p} \left(\text{v} \left|\text{h}\right)\right) \text{dh} \text{and} \text{p} \left(\text{v} \left|\text{h}\right)\right) = {\prod }_{\text{i=1}}^{{\text{N}}_{\text{d}}} \text{p} \left({\text{v}}_{\text{i}} \left|\text{h}\right)\right) \qquad \text{[Equation 3]}$$

where Nd is the number of words in document d. However, it may be intractable to sample all possible configurations of h ~ p(h). Therefore, TM may use neural variational inference framework to compute evidence lower bound LNTM as equation 4.

$${\text{L}}^{\text{NTM}} = {\text{E}}_{\text{q} \left(\text{h} \left|\text{v}\right)\right)} \left[{\sum }_{\text{i=1}}^{{\text{N}}_{\text{d}}} log \text{p} \left({\text{v}}_{\text{i}} \left|\text{h}\right)\right)\right] - \text{KLD} \qquad \text{[Equation 4]}$$

Here L^{NTM} being a lower bound i.e., log p(v) ≥ L^{NTM}, the TM maximizes the log-likelihood of documents log p(v) by maximizing the evidence lower bound itself. The L^{NTM} can be maximized via back-propagation of gradients w.r.t. model parameters using the samples generated from posterior distribution q(h|v). TM may assume both prior p(h) and posterior q(h|v) distributions as Gaussian and hence employ KL-Divergence as a regularizer term to conform q(h|v) to the Gaussian assumption i.e., KLD = KL[q(h|v)||p(h)], mentioned in equation 4.

[Algorithm 1]: Computation of combined loss L

1: Input: sentence s= {(wₘ, yₘ) |∀m=1:M}
2: Input: v=[v₁, ..., v_{z}] ∈ R^{z} of document d-s
3: Input: pretrained embedding matrix E
4: Parameters: {W, U, b, a, ƒ^{MLP}, l₁, l₂, ƒ^{LSTM}}
5: Hyper-parameters: {α,topN,g}
6: Initialize: p(h) ≡ N(h|0, diag(I))
7: Initialize: p (v | h) ← 0;p(s|v) ←0; r₀ ← 0
8:
9: Neural Topic Model:
10: Sample Latent Topic Representation (LTR) h
11: h, q(hjv) ← SAMPLE-h (ƒ^{MLP}, g, v, ,l₁,l₂, sigmoid)
12: Compute KL divergence between true prior p(h) and
q(h|v)
13: KLD ← KL [q(h|v) | |p (h)]
14: for i from 1 to Z do
15: $\text{p} \left({\text{v}}_{\text{i}} \left|\text{h}\right)\right) ← \frac{exp \left\{{h}^{T} {W}_{: , i} + {b}_{i}\right\}}{{\sum }_{j = 1}^{Z} exp \left({h}^{T} {W}_{: , j} + {b}_{j}\right)}$ 16: p(vlh) ← p(vlh) + p(vᵢ|h)
17: end for
18: L^{NTM} ← - (logp(v|h)- KLD)
19: if ETA or LETA then
20: Extract Explainable Topic Representation (ETR)
21: ${z}_{d - s}^{a t t}$ ←GET-ETR (W, v, topN, h, E)
22: end if
23:
24: Neural Composite Language Model:
25: for m from 1 to M do
26: oₘ, rₘ ← ƒ^{LSTM} (rₘ₋₁; wₘ)
27: Composition of NTM and NLM
28: if LTA then
29: ôₘ ← (oₘ ◊ h_{d-s})
30: else if ETA then
31:
32: else if LETA then
33: ${\hat{o}}_{\text{m}} ← \left({\text{o}}_{\text{m}} ⋄ \left[{\text{h}}_{\text{d} - \text{s}} ; {z}_{d - s}^{a t t}\right]\right)$
34: end if
35: $\text{p} \left({\text{y}}_{\text{m}} \left|{\text{o}}_{\text{m}} , \text{v}\right)\right) = \frac{exp \left\{\hat{o} {\text{m}}^{T} {U}_{: , y m} + {a}_{y m i}\right\}}{{\sum }_{j = 1}^{V} exp \left(\hat{o} {\text{m}}^{T} {U}_{: , j} + {b}_{j}\right)}$
36: p(s|v) = p(s|v) + p (yₘ|oₘ, v)
37: end for
38: L^{NLM} ← -log p(s|v)
39: L ← L^{NTM} + (1 - α) · L^{NLM}

Back to FIG. 3, in step S304, the apparatus may generate a second type of topic representation based on predefined number of key terms for each topic of the topic distribution represented by the first topic representation. In this disclosure, the second type of representation may be referred to as representation of explainable topic or explainable attentive topic representation (ETR) . The second type of topic representation may be obtained from key terms which are extracted from the first type of topic representation.

[Algorithm 2]: Utility functions

1: function GET-ETR (W, v, topN, h,E)
2: Extract topN words from each topic belonging to d
3: t ← topic-extract (W, v, topN)
4: Embedding lookup and summation to get topic
embedding
5: for k from 1 to K do
6: ${\text{z}}^{\text{k}} = \frac{{\sum }_{j = 1}^{t o p N} e m b \_ l o o k u p \left(E , {t}_{j}^{k}\right)}{t o p N}$
7: end for
8: Weighted sum of all topic embeddings
9: ${\text{z}}^{\text{att}} = {\sum }_{k = 1}^{K} \left({z}^{k} ⋅ {\hat{h}}^{k}\right) ; \hat{h} = \text{softmax} \left(\text{h}\right)$
10: return z^{att}
11: end function
12:
13: function SAMPLE-h (f, g, v, l₁, l₂, act)
14: Sample h via gaussian distribution conditioned
on v
15: π ← act(ƒ(v)) ; ∈ ~ N(∈|0, diag (I))
16: µ(v) ← l₁ (π) ; σ(v) ← l₂(π)
17: q (h|v) = N(h|µ(v), diag(σ²(v)))
18: h ← (µ(v) + ∈ ⊙ σ(v)) ~ q(h|v)
19: return g(h), q(h|v)
20: end function
21:
22: function TOPIC-EXTRACT (W, v, topN)
23: Create mask matrix D ∈ R^{K×Z} initialized with 0
24: for i from 1 to Z do
25: replace all 0 with 1 in column D_{:,I} if vᵢ is
non-zero
26: end for
27: Take hadamard product and find topN max values
28: t=row-argmax [W⊙D] _{1:} _{topN}
29: return t
30: end function

Beyond the latent topics, explainable topics (a fine-granularity description as illustrated in FIG. 1) that can be obtained from high probability key terms (top-N key terms) of a topic-word distribution corresponding to each latent topic k may be generated.

The predefined number of key terms for each topic may be extracted from the first topic representation by using a decoding weight parameter which represents word distribution for each topic of the at least one document. The predetermined number of key terms may be extracted based on the topic distribution for each word. The decoding weight parameter, W ∈ R^{K×Z} may be a topic matrix where each kth row Wₖ ∈ R^{z} denotes a distribution over vocabulary words for kth topic. As illustrated in FIG. 4(b), the predetermined number (N) of key terms may be extracted by using the utility TOPIC-EXTRACT as described in Algorithm 2. Referring to Algorithm 2, lines #1-11 and lines #22-30 describe the mechanism of topic learning and extracting explainable topic using GET-ETR function. It may be observed that the utility TOPIC-EXTRACT filters out key terms not appearing in the document being modeled in order to highlight the contribution of those topical words shared in topic-word distribution and the collection of documents itself. Specifically, utility TOPIC-EXTRACT may return K lists of key terms explaining each latent topic hₖ, i.e., t = [t^{k}|k=1:K] such that t^{k} had top-N key terms for k^{th} topic. A mask D may be used to apply the filter as equation 5.

$$\text{t = row} - \text{argmax} {\left[\text{W} ⊙ \text{D}\right]}_{1 : \text{topN}} \qquad \text{[Equation 5]}$$

Where, “row-argmax” is a function which returns indices of top-N values from each row of input matrix, ⊙ is an element-wise hadamard product, and D ∈ R^{K×Z} is an indicator matrix where each column D_{:,i} ∈ {1^{K} if ≠ 0; 0^{K} otherwise}.

As shown in FIG. 4(b), the second type of topic representation (404) may be generated by word embedding lookup from the key terms for each topic. For each latent topic k, word embedding lookup may be performed by using matrix E ∈ R^{D_{E}×Z} (pretrained word embeddings) for each word index in t^{k} and then average them to compute the explanatory topic-embedding vector z^{k} as shown in equation 6.

$${\text{z}}^{\text{k}} = \frac{{\sum }_{\text{j=1}}^{\text{topN}} \text{emb\_lookup} \left({\text{E,t}}_{\text{j}}^{\text{k}}\right)}{\text{topN}} \qquad \text{[Equation 6]}$$

Finally, the second type of topic representation 404 may be generated based on topic embedding vector computed from the key terms. Each entry of the topic embedding vector may be associated with a topic, and wherein the topic embedding vector is, for generating the second type of the topic representation, weighted by the topic proportion of the associated topic within the at least one document. The apparatus may perform weighted sum of topic vectors z^{k} using document-topic proportion vector h as weights to compute the second type of topic representation 404 as equation 7. The second type of representation may be denoted as z^{att} for collection of documents d. As shown In FIG. 4(b), the second type of topic representation 404 may be also denoted as z^{att}.

$${\text{z}}^{\text{att}} = {\sum }_{\text{k=1}}^{\text{K}} \left({\text{z}}^{\text{k}} ⋅ {\hat{\text{h}}}^{\text{k}}\right) \text{and} \hat{\text{h}} = \text{softmax} \left(\text{h}\right) \qquad \text{[Equation 7]}$$

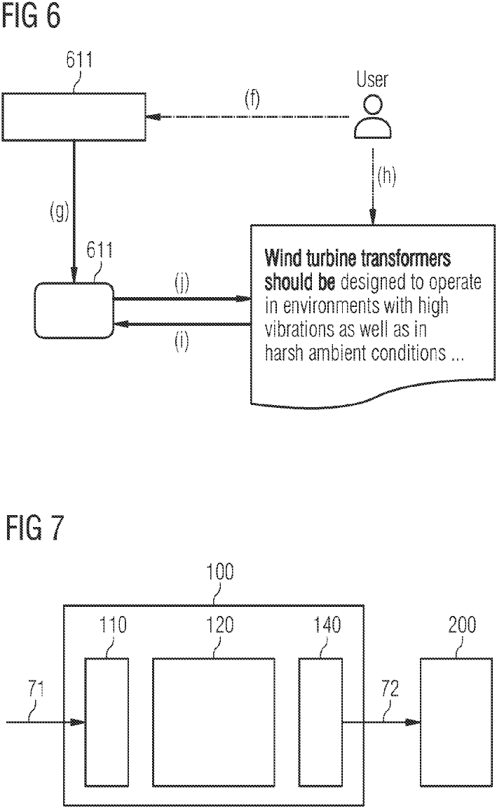

In some embodiments, as shown in FIG. 6, the key terms may be typed by a user. In this case, the second topic representation may be generated from the key terms input by the user. Back to FIG. 3, in step S306, the apparatus may generate a TM representation comprising at least one of the first type of topic representation and the second type of topic representation. In other words, the TM representation may include the first type of topic representation, the second type of topic representation, or a combination of the first type of topic representation and the second type of topic representation. As shown in FIG. 4(b), the TM representation 406 may be denoted as c (or c_{d}).

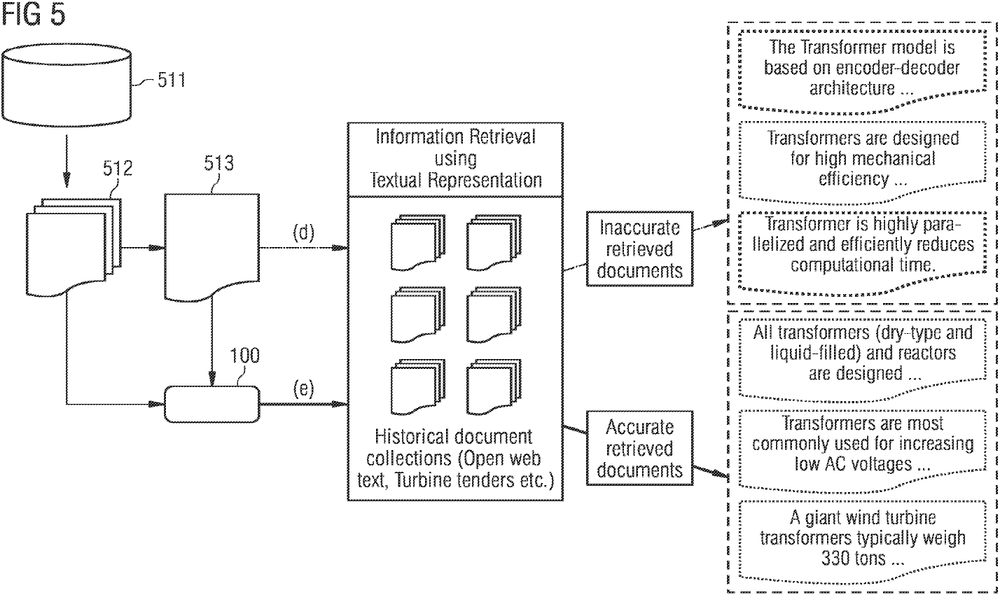

In step S308, the apparatus may receive an input sentence for a LM. The input sentence may be a complete sentence, or a portion of the complete sentence. The LM may be one of word-sense disambiguation (WSD) task or LM task. The WSD task may be an open problem concerned with identifying which sense of a word is used in a sentence and the LM task may be an open shared task for language modeling. In case the LM is the LM task, the input sentence may be an incomplete sentence. In case the LM is the WSD task, the input sentence may be a complete sentence, which is extracted from at least one document. Embodiments for WSD task and LM task are described in FIG. 5 and FIG. 6, respectively.

In step S310, the apparatus may perform a language modeling (LM) based on the TM representation in response to an input sentence to the LM. As shown in FIG. 4(c), the LM may be performed based on combination of the TM representation 406 and the output state 408. In case the LM is the LM task, performing LM includes completing the incomplete sentence based on the TM representation 406. In case the LM is the WSD task, performing LM includes text retrieval based on the TM representation 406. The text retrieval according to an embodiment of the present disclosure guarantees accurate retrieved document, which corresponds to semantics of at least one document.

More specifically, an output state 408 of an output word may be generated by the LM in response to the input sentence, and the output state 408 may be combined with the TM representation 406. The output state 408 and the TM representation 406 are combined by a sigmoid function. Referring to FIG. 4(c), the output state 408 may be also denoted as ‘o’.

Hereinafter, a general procedure of the LM is described. Consider a sentence s = {(wₘ, yₘ) | ∀ₘ=1:M} of length M in document d, where (wₘ, yₘ) is a tuple containing the indices of input and output words in vocabulary of size V. A LM may compute the joint probability p(s) i.e., likelihood of s by a product of conditional probabilities as equation 8.

$$\text{p} \left(\text{s}\right) = \text{p} \left({\text{y}}_{1} , … , {\text{y}}_{\text{M}}\right) = \text{p} \left({\text{y}}_{1}\right) {\prod }_{\text{m=2}}^{\text{M}} \text{p} \left({\text{y}}_{\text{m}} \left|{\text{y}}_{1 : \text{m} - \text{1}}\right)\right) \qquad \text{[Equation 8]}$$

Where, p (yₘ|y_{1:m-1}) is the probability of word yₘ conditioned on preceding context y_{1:m-1}. The LM may generate hidden state rₘ and output state oₘ of input words wₘ and output words yₘ such as to predict an output sentence. The hidden state rₘ and output state oₘ may be represented in form of a vector. Thus, the output state may be also referred to as an output vector. More specifically, RNN-based LMs may capture linguistic properties in its recurrent hidden state rₘ ∈ R^{H} and compute output state oₘ ∈ R^{H} for each yₘ as described in equation 9.

$${\text{o}}_{\text{m}} , {\text{r}}_{\text{m}} = \text{f} \left({\text{r}}_{\text{m} - \text{1}} , {\text{w}}_{\text{m}}\right) ; \text{p} \left({\text{y}}_{\text{m}} \left|{\text{y}}_{1 : \text{m} - \text{1}}\right)\right) = \text{p} \left({\text{y}}_{\text{m}} \left|{\text{o}}_{\text{m}}\right)\right) \qquad \text{[Equation 9]}$$

where function f(·) can be a standard LSTM (Hochreiter & Schmidhuber, “Long short-term memory”, 1997) or GRU (Cho et al., “Learning phrase representations using RNN encoder-decoder for statistical machine translation”, 2014) cell and H is the number of hidden units. As illustrated in FIG. 4(c), the LM may be based on LSTM, i.e., f=f^{LSTM}. Then, the conditional p (yₘ|oₘ) is computed using multinomial logistic as equation 10.

$$\text{p} \left({\text{y}}_{\text{m}} \left|{\text{o}}_{\text{m}}\right)\right) = \frac{exp \left({\text{o}}_{\text{m}}^{\text{T}} {\text{U}}_{: , {\text{y}}_{\text{m}} + {\text{a}}_{{\text{y}}_{\text{m}}}}\right)}{{\sum }_{\text{j=1}}^{\text{V}} exp \left({\text{o}}_{\text{m}}^{\text{T}} {\text{U}}_{; , \text{j}} + {\text{a}}_{\text{j}}\right)} \qquad \text{[Equation 10]}$$

where U ∈ R^{H×V} and a ∈ R^{V} are LM decoding parameters. Here, the input wₘ and output yₘ indices may be related as yₘ = wₘ₊₁. Finally, LM may compute log-likelihood L^{NLM} of s as a training objective and maximizes it as described in equation 11.

$${L}^{N L M} = log p \left({y}_{1}\right) {\sum }_{m = 2}^{M} log p \left({y}_{m} \left|{o}_{m}\right)\right) \qquad \text{[Equation 11]}$$

Hereinafter, a LM with composition of TM is described.

It may be described that the composition of TM representation 406, c_{d} ∈

$$\left\{{\text{h}}_{\text{d}} , {\text{z}}_{\text{d}}^{\text{att}}\right\}$$

with the output state 408, o such that LM is aware of document-level semantics while language modeling. As described above, TM representation 406 and the output state 408 of LM may be combined by a sigmoid function. As shown in FIG. 4(c), It may be denoted that composition function by (o ◊ c_{d}), where the apparatus first concatenate the two complementary representations (o and c_{d}) and then perform a projection as equation 12.

$$\hat{o} = \left(\text{o} ⋄ {\text{c}}_{\text{d}}\right) = \text{sigmoid} \left({\left[{\text{o;c}}_{\text{d}}\right]}^{\text{T}} {\text{W}}^{\text{p}} + {\text{b}}^{\text{p}}\right) \qquad \text{[Equation 12]}$$

where W^{p} ∈ R^{Ĥ×H} and b^{p} ∈ R^{H} are projection parameters, and Ĥ = H + K. the output state (o) from equation 10 is replaced by (o ◊ c_{d}). The apparatus then may compute prediction probability of output word y using equation 13.

$$\text{p} \left({y}_{m} \left|o , {c}_{d}\right)\right) = \frac{exp \left({\hat{o}}^{T} {U}_{: , y} + {a}_{y}\right)}{{\sum }_{j = 1}^{\left|V\right|} exp \left({\hat{o}}^{T} {U}_{: , j} + {a}_{j}\right)} \qquad \text{[Equation 13]}$$

The procedure of computing prediction probability using equation 12 is performed in a softmax layer as shown in FIG. 4(c).

In combining the TM and the LM, to remove the chances of the LM memorizing the next word due to input to the TM, the apparatus may exclude the current sentence from the document before input to the TM. The current sentence may be an input sentence of the LM. Thus, for a given document d and a sentence s on the LM, the system may compute an LTR vector h_{d-s} by modeling d-s sentences on TM. In other words, sentence s being modeled at the LM side is removed from the document d at the TM side. Therefore, the input sentence input to the LM may be excluded from the at least one document input to the TM. In this case, the LM may be a WSD task.

When the TM representation 406 only includes the first type of topic representation 402, the system may compose it with output vector o of LM to obtain a representation

$${\text{o}}_{\text{d}}^{\text{LTA}}$$

using equation 11, i.e.,

$${\text{o}}_{\text{d}}^{\text{LTA}} = \left(\text{o} ⋄ {\text{h}}_{\text{d} - \text{s}}\right) .$$

This scheme of composition may be referred to as latent topic aware neural language model (LTA-NLM).

When the TM representation 406 only includes the second type of topic representation 404, the second type of topic representation 404 may be used in composition with the LM. In doing so, the apparatus may compose second type of topic representation 404

$${\text{o}}_{\text{d}}^{\text{ETA}}$$

of d-s sentences in a document d with output vector 408 of LM to obtain

$${\text{o}}_{\text{d}}^{\text{ETA}}$$

using equation 6, i.e.,

$${\text{o}}_{\text{d}}^{\text{ETA}} = \left(\text{o} ⋄ {\text{z}}_{\text{d} - \text{s}}^{\text{att}}\right) .$$

This newly composite vector

$${\text{o}}_{\text{d}}^{\text{ETA}}$$

encodes fine-grained explainable topical semantics to be used in the sequence modeling task. This scheme of composition may be referred to asexplainable topic-aware neural language model (ETA-NLM).

When the TM representation 406 includes both the first type of topic representation 402 and the second type of topic representation 404, the apparatus may leverage the two complementary topical representations using the latent hd-s and explainable

$${\text{z}}_{\text{d} - \text{s}}^{\text{att}}$$

vectors jointly. The apparatus may concatenate them to generate the TM representation 406 and compose the TM representation 406 combined with the output vector 408 of the LM to obtain

$${\text{o}}_{\text{d}}^{\text{LETA}}$$

using equation 11, i.e.,

$${\text{o}}_{\text{d}}^{\text{LETA}} = \left(o ⋄ \left[h d - s ; {z}_{d - s}^{a t t}\right]\right) .$$

This scheme of composition may be referred to as LETA-NLM due to the latent and explainable topic vectors.

Referring to FIG. 2, it seems that there is a need for sentence-level topics in order to avoid dominant topic mismatch. Thus, we retain sentence-level topical discourse (SDT) by incorporating sentence-topic associations/proportion (latent and/or explainable) while modeling the sentence on the LM. To avoid memorization of current word being predicted y, we remove the current word from sentence s i.e., s-y is input to the TM to compute its topic-proportion.

In some embodiments, the at least one document input to the TM may exclude an input sentence s which is input to the LM. That is, the apparatus may perform the TM for the document which does not include the input sentence s. Moreover, the apparatus may perform the TM for the input sentence s which excludes an output word y generated by the LM to acquire a first type of topic representation for the input sentence s, which does not include the output word y. Further, the apparatus may generate a second type of topic representation for the input sentence s, which does not include the output word y. In this case, TM representation may further comprise the first type of topic representation for the input sentence s, the second type of topic representation for the input sentence s, or a combination of the first type of topic representation for the input sentence s and the second type of topic representation for the input sentence s.

Given the latent and explainable topic representations, the apparatus may first extract sentence-level LTR h_{s-y} and ETR

$${\text{z}}_{\text{s} - \text{y}}^{\text{att}}$$

vectors and then concatenate these with the corresponding document-level LTR and/or ETR vectors before composing them with the LM. Similarly, these composed output vectors are used to assign probability to the output word y using equation 13.

Hereinafter, the additional compositions for every sentence s in a document d are defined:

$$\text{LTA} - \text{NLM+SDT :} {o}_{d , s}^{L T A} = \left(\text{o} ⋄ \left[{\text{h}}_{\text{d} - \text{s}} ; {\text{h}}_{\text{s} - \text{y}}\right]\right)$$

$$\text{ETA} - \text{NLM+SDT :} {o}_{d , s}^{E T A} = \left(\text{o} ⋄ \left[{z}_{d - s}^{a t t} ; {z}_{s - y}^{a t t}\right]\right)$$

$$\text{LETA} - \text{NLM+SDT :} {o}_{d , s}^{L E T A} = \left(\text{o} ⋄ \left[{\text{h}}_{\text{d} - \text{s}} ; {\text{h}}_{\text{s} - \text{y}} ; {z}_{d - s}^{a t t} ; {z}_{s - y}^{a t t}\right]\right)$$

FIG. 5 shows an example of applications for language modeling incorporating teachings of the present disclosure. Referring to FIG. 5, an example of word-sense disambiguation (WSD) task performed by the apparatus or method according to the present disclosure is schematically depicted. In computational linguistics, the WSD task is an open problem concerned with identifying which sense of a word is used in a sentence. The solution to this issue impacts other computer-related writing, such as discourse, improving relevance of search engines, anaphora resolution, coherence, and inference.

Disambiguation requires two strict inputs: a dictionary to specify the senses which are to be disambiguated and a corpus of language data to be disambiguated (in some methods, a training corpus of language examples is also required). The WSD task has two variants: “lexical sample” and “all words” task. The former comprises disambiguating the occurrences of a small sample of target words which were previously selected, while in the latter all the words in a piece of running text need to be disambiguated. The latter is deemed a more realistic form of evaluation, but the corpus is more expensive to produce because human annotators have to read the definitions for each word in the sequence every time they need to make a tagging judgement, rather than once for a block of instances for the same target word.

The proposed apparatus and methods comprising explainable and discourse-aware composite language modeling approaches may be used to encode textual representations of industrial documents, such as tender documents, at the sentence-level which can further help an expert or technician to analyze the documents via text retrieval or text classification for each requirement object in a fine-grained fashion and, thus, improves textual language understanding.

For instance, as shown in FIG. 5, at least one document 512 may be derived from database 511. The database 511 may include, for example, industrial tender documents, service reports, specification documents, etc. regarding a transformer. The at least one document 512 may be, for example, a tender document for turbine transformer. The at least one document may be input to the apparatus 100 according to an embodiment of the present disclosure. The apparatus 100 may perform the TM based on at least one document 512. As described above, the apparatus 100 may generate a first type of topic representation 402 and a second type of topic representation 404, and generate a TM representation 406. The second type of topic representation 404 may represent a plurality of topic terms (for example, turbine, voltage, wind, step, AC, reactor, etc.).

Meanwhile, an input sentence 513 may be extracted from at least one document 512. For example, the input sentence 513 may be “Transformer should be designed to efficiently reduce losses”. The input sentence 513 may be input to the apparatus 100. As describe above, the apparatus 100 may perform the LM based on the TM representation 406 in response to the input sentence 513.

More specifically, for a given tender document, the word “transformer” is related to “electrical equipment” category, but this is not clear from the context of the requirement alone which leads to inaccurate retrieval from document collections relating to “transformer” architecture related to “neural networks” category. But the top key topic terms extracted from the whole tender document via topic model help in generating a semantically coherent representation of the requirement using the apparatus 100 according to the present disclosure which is corroborated via accurate and semantically related retrieval of documents.

As marked as e in FIG. 5, the apparatus 100 according to an embodiment of the present disclosure may guarantee accurate retrieved documents. On the other hand, as marked as d in FIG. 5, a legacy method for language modeling may lead to inaccurate retrieved documents.

FIG. 6 shows an example of applications for language modeling according to an embodiment of the present disclosure. Referring to FIG. 6, an example of the LM task performed by the apparatus or method incorporating teachings of the present disclosure is schematically depicted. The LM task is an open shared task for language modelling. For example, the LM task is to assign scores to sentences, based on their quality. The dataset contains 10,000 sentences that need to be scored. The sentences are in pairs - one correct and one incorrect sentence. The paired sentences are kept together in the dataset, but it is randomly selected whether the correct sentence is first or second.

As noted by f in FIG. 6, the user may input key terms 611. The user enters a “list of key terms” related to a topic on which the requirement is going to be written. The key terms 611 may be, for example, wind, turbine, transformer, step, AC, reactor, efficiency, loss, design, etc. As noted by g in FIG. 6, the key terms may be input to the apparatus 100. The key terms 611 may be used for identifying topics, and the key terms 611 may be input to the apparatus 100 as topic signal for topically guided text generation. The key terms may correspond to TM representation 406 described above.

As noted by h in FIG. 6, the user may write an input sentence. The input sentence may be an incomplete sentence, for example, “Wind turbine transformers should be”. As noted by i in FIG. 6, the input sentence may be delivered to the apparatus 100.

The apparatus 100 may perform the LM task based on key terms, in particular, complete the input sentence. The apparatus 100 may suggest contextualized text to the user, as noted by j.

In some embodiments, it may be helpful in reducing the document generation time by assisting the user, an expert or a technician, in writing the tender requirements via auto-completion. The apparatus 100 according to the present disclosure (also referred to as TenGen: Tender-Requirement Generator) may assist bidders and tender authors in writing requirements about topics of interest by automatic text generation supported by topics. The TenGen component may also offer profiling experts based on their expertise and auto-generate requirements profiled by the author expertise.

FIG. 7 shows an apparatus 100 incorporating teachings of the present disclosure. In particular, the apparatus 100 is configured to perform one or more of the methods described herein. The apparatus 100 comprises an input interface 110 for receiving an input signal 71, wherein the task is to perform the bootstrapping. The input interface 100 may be realized in hard-and/or software and may utilize wireless or wire-bound communication. For example, the input interface 110 may comprise an Ethernet adapter, an antenna, a glass fiber cable, a radio transceiver and/or the like.

The apparatus 100 further comprises a computing device 120 configured to perform the steps S302 through S310. The computing device 120 may in particular comprise one or more central processing units, CPUs, one or more graphics processing units, GPUs, one or more field-programmable gate arrays FPGAs, one or more application-specific integrated circuits, ASICs, and or the like for executing program code. The computing device 120 may also comprise a non-transitory data storage unit for storing program code and/or inputs and/or outputs as well as a working memory, e.g. RAM, and interfaces between its different components and modules.

The apparatus may further comprise an output interface 140 configured to output an output signal 72. The output signal 72 may have the form of an electronic signal, as a control signal for a display device 200 for displaying the semantic relationship visually, as a control signal for an audio device for indicating the determined semantic relationship as audio and/or the like. Such a display device 200, audio device or any other output device may also be integrated into the apparatus 100 itself.

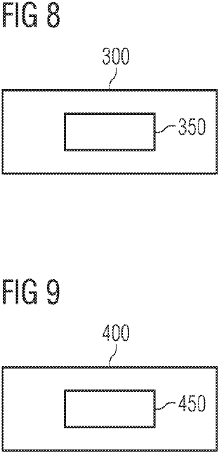

FIG. 8 shows a schematic block diagram illustrating a computer program product 300 incorporating teachings of the present disclosure, i.e. a computer program product 300 comprising executable program code 350 configured to, when executed (e.g. by the apparatus 100), perform one or more of the methods described herein.

FIG. 9 shows a schematic block diagram illustrating a non-transitory computer-readable data storage medium 400 according to an embodiment of the present disclosure., i.e. a data storage medium 400 comprising executable program code 450 configured to, when executed (e.g. by the apparatus 100), perform one or more of the methods as described herein.

In the foregoing detailed description, various features are grouped together in the examples with the purpose of streamlining the disclosure. It is to be understood that the above description is intended to be illustrative and not restrictive. It is intended to cover all alternatives, modifications and equivalence. Many other examples will be apparent to one skilled in the art upon reviewing the above specification, taking into account the various variations, modifications and options as described or suggested in the foregoing.

What is claimed is:

1. A computer-implemented method for a language modeling, LM, the method comprising:
performing a topic modeling, TM, for at least one document to acquire a first type of topic representation which represents a topic distribution for each word in the at least one document;
generating a second type of topic representation based on a predefined number of key terms for each topic of the topic distribution represented by the first topic representation;
generating a TM representation comprising the first type of topic representation, the second type of topic representation, or a combination of the first type of topic representation and the second type of topic representation;
receiving an input sentence for the LM; and
performing the LM on the input sentence based on the TM representation.

2. The method of claim 1, further comprising extracting the predefined number of key terms for each topic from the first topic representation using a decoding weight parameter which represents a word distribution for each topic of the at least one document.

3. The method of claim 1, wherein the first type of topic representation further represents a topic proportion within the at least one document.

4. The method of claim 3, further comprising generating the second type of topic representation based on a topic embedding vector computed from the key terms.

5. The method of claim 4, wherein each entry of the topic embedding vector is associated with a topic, and wherein the topic embedding vector is, for generating the second type of the topic representation, weighted by the topic proportion of the associated topic within the at least one document.

6. The method of claim 1, further comprising generating an output state for an output word is generated by the LM in response to the input sentence, and the output state is combined with the TM representation.

7. The method of claim 6, wherein the output state and the TM representation are combined by a sigmoid function.

8. The method of claim 1, wherein:
the input sentence is an incomplete sentence; and
performing the LM includes completing the incomplete sentence based on the TM representation.

9. The method of claim 1, wherein the input sentence is a complete sentence which is extracted from the at least one document.

10. The method of claim 9, wherein the input sentence is excluded from the at least one document; and
the method further comprises:
performing the TM for the input sentence to acquire a first type of topic representation for the input sentence, wherein at least one of output words generated by the LM is excluded from the input sentence, and
generating a second type of topic representation for the input sentence.

11. The method of claim 10, wherein the TM representation is generated to further comprise the first type of topic representation for the input sentence, the second type of topic representation for the input sentence, or a combination of the first type of topic representation for the input sentence and the second type of topic representation for the input sentence.

12. The method of claim 9, wherein performing the LM includes performing text retrieval based on the TM representation.

13-15. (canceled)
